(19) United States
(12) Patent Application Publication
(10) Pub. No.: US 2026/0320249 A1
(43) Pub. Date: Oct. 15, 2026

(54) METHOD AND SYSTEM FOR CALCULATING COMPREHENSIVE STRESSES OF BITTER DISKS OF WATER-COOLED MAGNET

(71) Applicant: HEFEI INSTITUTES OF PHYSICAL SCIENCE, CHINESE ACADEMY OF SCIENCES, Hefei (CN)

(72) Inventors: Zhen FANG, Hefei (CN); Guangli KUANG, Hefei (CN); Jian LI, Hefei (CN); Zhongjian WANG, Hefei (CN); Xinxing QIAN, Hefei (CN); Jian SU, Hefei (CN); Yong ZHANG, Hefei (CN)

(21) Appl. No.: 18/996,547

(22) PCT Filed: Mar. 11, 2024
(86) PCT No.: PCT/CN2024/080979

§ 371 Date: Jan. 17, 2025

(30) Foreign Application Priority Data
Nov. 14, 2023 (CN) CN 202311510763.6

(51) Int. Cl. G06F 30/23

(52) U.S. Cl. CPC G06F 30/23

(57) ABSTRACT

Disclosed is a method for calculating comprehensive stresses of Bitter disks of water-cooled magnet, including: building, in finite element analysis software, simplified coil model by using multiple 3-dimensional Bitter disks with slits and without helix angles (S10); meshing the coil model to obtain meshed nodes (S20); applying boundary condition and load condition to meshed coil model and performing simulation, boundary condition including applying corresponding node displacement coupling condition to slit in each of Bitter disks on upper and lower end faces of the coil model and setting contact pairs on all contact surfaces between Bitter disks, load condition including loading electromagnetic force into all nodes of the coil model and applying axial force to upper end face of the coil model (S30); and calculating stress distribution of Bitter disks based on simulation result (S40). Further disclosed is a system for calculating comprehensive stresses of Bitter disks of water-cooled magnet.

### CROSS-REFERENCE TO RELATED APPLICATIONS

The present disclosure claims priority to Chinese Patent Application No. 202311510763.6 filed with the China National Intellectual Property Administration on Nov. 14, 2023, the entire contents of which are incorporated herein by reference.

### TECHNICAL FIELD

The present disclosure relates to the field of water-cooled magnet simulation technologies, and in particular, to a method for calculating comprehensive stresses of Bitter disks of a water-cooled magnet and a system therefor.

### BACKGROUND

Water-cooled magnet is an important part of steady high magnetic field facility, and is a main experimental apparatus in high magnetic field laboratory. The water-cooled magnet has become a highly concerned extreme-condition experimental platform due to its characteristics such as high magnetic field strength and fast magnetic excitation. Currently, a maximum magnetic field of the water-cooled magnet can reach more than 40 T. With reference to FIG. 1 to FIG. 4, a Bitter disk 6 (as shown in FIG. 1) and an insulating plate 7 (as shown in FIG. 2) are two basic elements that make up a water-cooled magnet coil. Multiple Bitter disk cooling water holes 3 are arranged in the Bitter disk 6, and a radial slit 1 is provided in the Bitter disk 6. Multiple Bitter disk locating holes 2 are provided at an outer periphery of the Bitter disk 6. Multiple insulating plate cooling water holes 5 are arranged in the insulating plate 7. Multiple insulating plate locating holes are provided at an outer periphery of the insulating plate 7. According to a specific regular stacking manner shown in FIG. 3, Bitter disks 6 and insulating plates 7 are misaligned and stacked to form a spiral current channel, thereby making up the water-cooled magnet coil (as shown in FIG. 4).

The Bitter disk, which has to withstand a huge electromagnetic force, is generally made of a high-tensile copper alloy material with high conductivity. Accurate calculation of stress distribution of the Bitter disks under the electromagnetic force is a key in the design of the water-cooled magnet. In the document “Design of the Resistive Insert for the Nijmegen 45 T Hybrid Magnet, IEEE TRANSACTIONS ON APPLIED SUPERCONDUCTIVITY, VOL. 30, NO. 4, JUNE 2020”, it is proposed that a 2-dimensional circumferential symmetry model in ANSYS is used in stress calculation for Bitter disks. However, the 2-dimensional circumferential symmetry model can only calculate stress generated by an electromagnetic force along a radial direction, and cannot figure influences caused by an axial electromagnetic pressure perpendicular to a plane of the Bitter disk and interaction frictions between the Bitter disks on stress distribution. In addition, the 2-dimensional circumferential symmetry model ignores existence of the slit in the Bitter disk, thereby paying no attention on influence of the slit on the stress distribution. In view of the above, stress calculation for the Bitter disks using the 2-dimensional circumferential symmetry model may result in large error, and actual stress distribution on the Bitter disks cannot be accurately calculated.

### SUMMARY

The present disclosure is intended to solve the technical problem of how to obtain higher-precision stress distribution of Bitter disks while taking into account an amount of calculation and convergence.

In a first aspect of the present disclosure, a method for calculating comprehensive stresses of Bitter disks of a water-cooled magnet is proposed. The method includes: building, in a finite element analysis software, a simplified coil model by using multiple 3-dimensional Bitter disks each having a slit and have no helix angle; meshing the coil model to obtain meshed nodes; applying a boundary condition and a load condition to a meshed coil model and then performing simulation, where the boundary condition includes applying a corresponding node displacement coupling condition to the slit in each of the Bitter disks on upper and lower end faces of the coil model and setting contact pairs on all contact surfaces between the Bitter disks, and the load condition includes loading an electromagnetic force into all nodes of the coil model and applying an axial force to the upper end face of the coil model; and calculating stress distribution of the Bitter disks based on a result of simulation.

In the above first aspect, the method further includes: setting a friction coefficient between the conductor-insulating plate contact pair to an insulating contact surface friction coefficient, and setting a friction coefficient between the conductor-conductor contact pair to a conductive contact surface friction coefficient.

In the above first aspect, the coil model includes multiple Bitter disks arranged in sequence from bottom to top, and angles of the slits in respective Bitter disks increase along a same direction.

In the above first aspect, the coil model includes Bitter disks DISK1, DISK2, DISK3, DISK4 and DISK5 arranged in sequence from bottom to top, where the angles of the slits in DISK1 and DISK5 are both 180 degrees, and the angles of the slits in of DISK2, DISK3 and DISK4 are 360-a degrees, 0 degrees, and a degrees respectively, where a is a sector angle of an insulating plate.

In the above first aspect, between the Bitter disk DISK1 and the Bitter disk DISK2, a contact pair at a contact angle ranging from 360-2a to 360-a is a conductor-insulating plate contact pair, and a contact pair at a contact angle ranging from 0 to 360-2a or ranging from 360-a to 360 is a conductor-conductor contact pair; between the Bitter disk DISK2 and the Bitter disk DISK3, a contact pair at a contact angle ranging from 360-a to 360 is a conductor-insulating plate contact pair, and a contact pair at a contact angle ranging from 0 to 360-a is a conductor-conductor contact pair; between the Bitter disk DISK3 and the Bitter disk DISK4, a contact pair at a contact angle ranging from 0 to a is a conductor-insulating plate contact pair, and a contact pair at a contact angle ranging from a to 360 is a conductor-conductor contact pair; and between the Bitter disk DISK4 and the Bitter disk DISK5, a contact pair at a contact angle ranging from a to 2a is a conductor-insulating plate contact pair, and a contact pair at a contact angle ranging from 0 to a or ranging from 2a to 360 is a conductor-conductor contact pair.

In the above first aspect, each of the Bitter disks DISK2, DIS3, and DISK4 is in a combined state of radial expansion and cantilever beam movement of the slit.

In the above first aspect, the applying the corresponding node displacement coupling condition to the slit in each of the Bitter disks on the upper and lower end faces of the coil model includes: coupling displacements of corresponding nodes on the slit in each of the Bitter disks on the upper and lower end faces of the coil model respectively; and setting axial displacements of all nodes on the Bitter disk on the lower end face to 0, and setting all displacements of a node with a maximum node serial number on the Bitter disk on the lower end face to 0.

In a second aspect of the present disclosure, a system for calculating comprehensive stresses of Bitter disks of a water-cooled magnet is further proposed. The system includes a model building module, a model partition module, a condition application module, and a stress calculation module. The model building module is configured to build, in a finite element analysis software, a simplified coil model by using multiple 3-dimensional Bitter disks each having a slit and have no helix angle. The model partition module configured to mesh the coil model to obtain meshed nodes. The condition application module is configured to apply a boundary condition and a load condition to a meshed coil model and then perform simulation. The boundary condition includes: applying a corresponding node displacement coupling condition to the slit in each of the Bitter disks on upper and lower end faces of the coil model and setting contact pairs on all contact surfaces between the Bitter disks. The contact pairs include a conductor-insulating plate contact pair and a conductor-conductor contact pair. The load condition includes loading an electromagnetic force into all nodes of the coil model and applying an axial force to the upper end face of the coil model. The stress calculation module is configured to calculate stress distribution of the Bitter disks based on a result of simulation.

In the above second aspect, a friction coefficient between the conductor-insulating plate contact pair is set to an insulating contact surface friction coefficient, and a friction coefficient between the conductor-conductor contact pair is set to a conductive contact surface friction coefficient.

In the above second aspect, the coil model includes multiple Bitter disks arranged in sequence from bottom to top, and angles of the slits in respective Bitter disks increase along a same direction.

In the above second aspect, the coil model includes Bitter disks DISK1, DISK2, DISK3, DISK4 and DISK5 arranged in sequence from bottom to top, where the angles of the slits in DISK1 and DISK5 are both 180 degrees, and the angles of the slits in DISK2, DISK3 and DISK4 are 360-a degrees, 0 degrees, and a degrees respectively, where a is a sector angle of an insulating plate.

In the above second aspect, between the Bitter disk DISK1 and the Bitter disk DISK2, a contact pair at a contact angle ranging from 360-2a to 360-a is a conductor-insulating plate contact pair, and a contact pair at a contact angle ranging from 0 to 360-2a or ranging from 360-a to 360 is a conductor-conductor contact pair; between the Bitter disk DISK2 and the Bitter disk DISK3, a contact pair at a contact angle ranging from 360-a to 360 is a conductor-insulating plate contact pair, and a contact pair at a contact angle ranging from 0 to 360-a is a conductor-conductor contact pair; between the Bitter disk DISK3 and the Bitter disk DISK4, a contact pair at a contact angle ranging from 0 to a is a conductor-insulating plate contact pair, and a contact pair at a contact angle ranging from a to 360 is a conductor-conductor contact pair; and between the Bitter disk DISK4 and the Bitter disk DISK5, a contact pair at a contact angle ranging from a to 2a is a conductor-insulating plate contact pair, and a contact pair at a contact angle ranging from 0 to a or ranging from 2a to 360 is a conductor-conductor contact pair.

In the above second aspect, each of the Bitter disks DISK2, DISK3 and DISK4 is in a combined state of radial expansion and cantilever beam movement of the slit.

In the above second aspect, applying the corresponding node displacement coupling condition to the slit in each of the Bitter disks on the upper and lower end faces of the coil model includes: coupling displacements of corresponding nodes on the slit in each of the Bitter disks on the upper and lower end faces of the coil model respectively; and setting axial displacements of all nodes on the Bitter disk on the lower end face to 0, and setting all displacements of a node with a maximum node serial number on the Bitter disk on the lower end face to 0.

In a third aspect of the present disclosure, an electronic device is proposed. The electronic device includes a memory, a processor, and a computer program stored in the memory and executable by the processor. The processor, when executing the computer program, implements the method as described in the first aspect.

In a fourth aspect of the present disclosure, a computer-readable storage medium is proposed, having computer-executable instructions stored thereon. When the computer-executable instructions are executed by a processor, the processor is caused to implement the method as described in the first aspect.

### BRIEF DESCRIPTION OF THE DRAWINGS

FIG. 1 is a schematic structural diagram of Bitter disk of a water-cooled magnet in the related technology;

FIG. 2 is a schematic structural diagram of insulating plate of a water-cooled magnet in the related technology;

FIG. 3 is a schematic diagram of stacking of plates of a water-cooled magnet coil in the related technology;

FIG. 4 is a schematic structural diagram of a water-cooled magnet coil in the related technology;

FIG. 5 is a schematic flowchart of a method for calculating comprehensive stresses of Bitter disks of a water-cooled magnet according to an embodiment of the present disclosure;

FIG. 6 is an exploded view of a coil model built according to an embodiment of the present disclosure;

FIG. 7 is a diagram of stress distribution of Bitter disk DISK1 according to an embodiment of the present disclosure;

FIG. 8 is a diagram of stress distribution of Bitter disk DISK3 according to an embodiment of the present disclosure;

FIG. 9 is a schematic structural diagram of a system for calculating comprehensive stresses of Bitter disks of a water-cooled magnet according to an embodiment of the present disclosure; and

FIG. 10 is a schematic structural diagram of an electronic device according to an embodiment of the present disclosure.

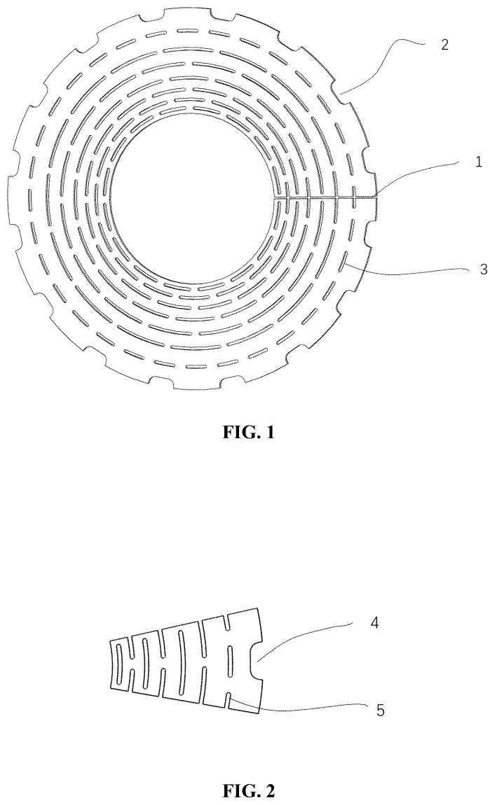

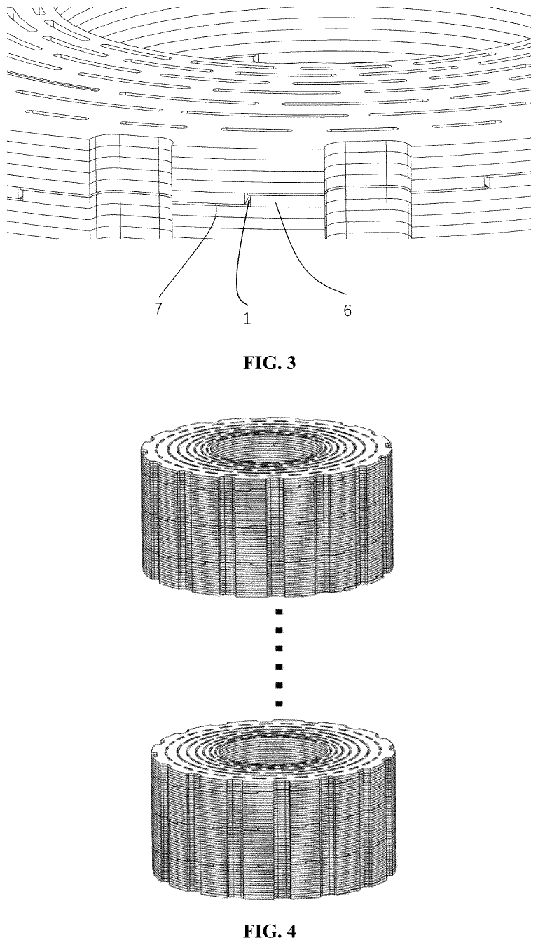

### DETAILED DESCRIPTION

In order to make the objectives, technical solutions, and advantages of the present disclosure clearer, the technical solutions in the embodiments of the present disclosure are clearly and completely described below in conjunction with the accompanying drawings in the present disclosure. Apparently, the described embodiments are merely some of rather than all of the embodiments of the present disclosure. All other embodiments acquired by those of ordinary skill in the art without creative efforts based on the embodiments of the present disclosure shall fall within the protection scope of the present disclosure.

Herein, the description with reference to the terms such as “an embodiment”, “some embodiments”, “example”, “specific example”, and “some examples” mean that a particular feature, structure, material, or characteristic described in connection with the embodiment or example is included in at least one embodiment or example of the present disclosure. Herein, the schematic expressions to the above terms are not necessarily referring to the same embodiment or example. Moreover, the particular feature, structure, material, or characteristic described may be combined in any suitable manner in any one or more embodiments or examples.

Although the terms “first” and “second” may be used herein to describe various features or elements, these features or elements should not be limited by these terms unless specifically stated otherwise. These terms may be used to distinguish one feature or element from another feature or element. Therefore, a first feature or element described below may be referred to as a second feature or element, and similarly, a second feature or element described below may be referred to as a first feature or element, without departing from the scope of the present disclosure.

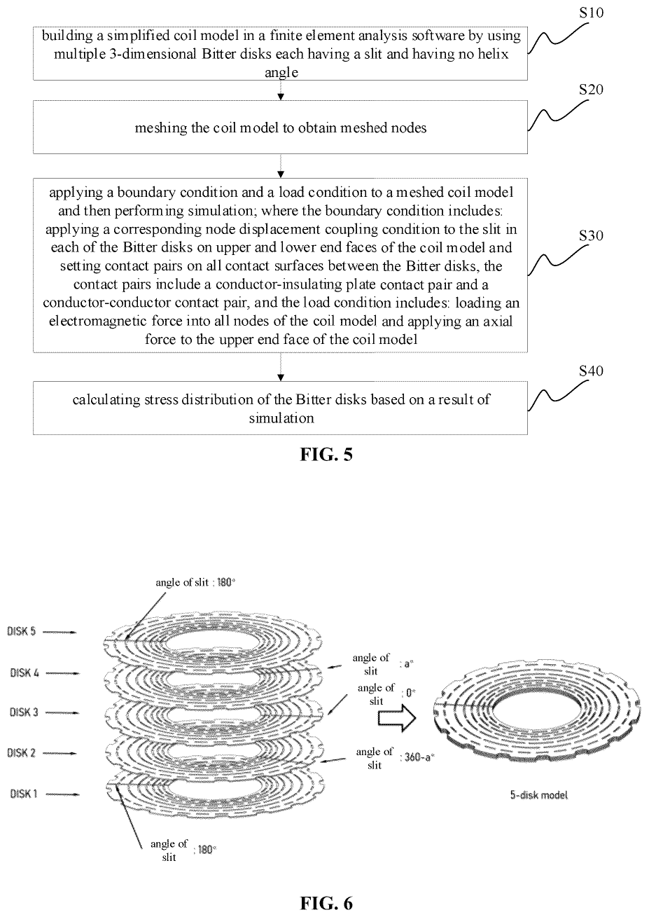

As shown in FIG. 5, a method for calculating comprehensive stresses of Bitter disks of a water-cooled magnet is provided according to an embodiment of the present disclosure. The method includes steps S10 to S40.

Step S10 includes: building a simplified coil model in a finite element analysis software by using multiple 3-dimensional Bitter disks each having a slit and having no helix angle.

In the embodiment, the finite element analysis software used may be ANSYS.

Step S20 includes: meshing the coil model to obtain meshed nodes.

Step S30 includes: applying a boundary condition and a load condition to a meshed coil model and then performing simulation; where the boundary condition includes: applying a corresponding node displacement coupling condition to the slit in each of the Bitter disks on upper and lower end faces of the coil model and setting contact pairs on all contact surfaces between the Bitter disks, the contact pairs include a conductor-insulating plate contact pair and a conductor-conductor contact pair, and the load condition includes: loading an electromagnetic force into all nodes of the coil model and applying an axial force to the upper end face of the coil model.

Step S40 includes: calculating stress distribution of the Bitter disks based on a result of simulation.

It is to be noted that, in the related technology, the water-cooled magnet coil is simplified into a 2-dimensional circumferential symmetry model of the Bitter disk, which takes a single Bitter disk as a research object. However, influences caused by an axial electromagnetic pressure perpendicular to a plane of the Bitter disk and interaction frictions between Bitter disks on stress distribution cannot be calculated, and since existence of the slit in the Bitter disk is ignored, an influence of the slit on the stress distribution is ignored. If there is a need to obtain a higher-precision result of stress distribution and achieve ideal calculation accuracy, when the water-cooled magnet is completely modeled and imported into the finite element calculation software (ANSYS) for simulation, since the water-cooled magnet coil is made up of thousands of Bitter disks and insulating plates that are misaligned and stacked, there generates a large number of model meshes and conventional computers cannot handle the calculation at all.

In the embodiment, a 3-dimensional Bitter disk model with a slit and without helix angle is established using ANSYS Parametric Design Language (APDL) in ANSYS software, and then a coil model is built based on the Bitter disk model. During the building of the coil model, a tiny helix angle of the Bitter disk in the coil is ignored, and contact pairs including a conductor-insulating plate contact pair and a conductor-conductor contact pair are set on contact surfaces between the Bitter disks. Therefore, spiral surface contact is converted into planar contact and insulating plate structures are removed, and necessary simplifications are made to the structure of the water-cooled magnet coil to ensure a small amount of calculation and high convergence of the finite element calculation model of the water-cooled magnet coil. Moreover, factors such as axial electromagnetic forces, frictions between the Bitter disks, and slits are incorporated into stress calculation to simulate radial electromagnetic forces and axial electromagnetic forces on the Bitter disks, the frictions between the Bitter disks, and the slits in the Bitter disks, which solves the influences caused by application of the axial electromagnetic forces and the slits on stress distribution, so that the calculated stress distribution of the Bitter disks is more accurate and more consistent with the actual stress distribution. Sufficient simplification of the coil model can be ensured, and a higher-precision result of stress distribution can be obtained.

Specifically, in the embodiment, the tiny helix angle of the Bitter disk in the coil is ignored first and the 3-dimensional Bitter disk model with the slit and without helix angle is established in the finite element analysis software,; at the same time, in the boundary condition, a conductor-insulating plate contact pair and a conductor-conductor contact pair are set on the contact surfaces between the Bitter disks to simulate an interaction scenario of frictions between the Bitter disks, thereby replacing the insulating plate structures in the coil model and simplifying the insulating plate structures in the model. A simplified calculation model of the coil is formed by duplicating and rotating multiple 3-dimensional Bitter disk models with slits and without helix angles. A role of the simplified coil model is to convert the spiral surface contact into planar contact and remove the insulating plate structures, which improves convergence of finite element calculation. Multiple Bitter disks are assembled to replace the complete coil, greatly reducing the amount of calculation. In addition, in the embodiment, the factors such as the axial electromagnetic forces, the frictions between the Bitter disks, and the slits are incorporated into stress calculation, which solves the influences caused by application of the axial electromagnetic forces and the slits on stress distribution, so that the calculated stress distribution of the Bitter disks is more accurate and more consistent with the actual stress distribution. Therefore, with the method for calculating comprehensive stresses of Bitter disks of the water-cooled magnet according to the embodiment, the coil model is sufficiently simplified and the pain points of the 2-dimensional circumferential symmetry model of the Bitter disks can be solved.

In an embodiment, the method further includes: setting a friction coefficient between the conductor-insulating plate contact pair to an insulating contact surface friction coefficient, and setting a friction coefficient between the conductor-conductor contact pair to a conductive contact surface friction coefficient.

In the embodiment, a contact surface between the Bitter disks and a friction surface between the Bitter disk and the insulating plate are defined through different friction coefficients, so as to simplify the insulating plates in the coil model. In particular, the interaction scenario of frictions between the Bitter disks is simulated by setting contact pairs on contact surfaces between the Bitter disks, setting the friction coefficient between the conductor-insulating plate contact pair to the insulating contact surface friction coefficient, and setting the friction coefficient between the conductor-conductor contact pair to the conductive contact surface friction coefficient.

In an embodiment, as shown in FIG. 6, the coil model includes multiple Bitter disks arranged in sequence from bottom to top, and angles of the slits in respective Bitter disks increase by one insulation angle along a same direction.

Specifically, the insulation angle is a sector angle of an insulating plate, which is determined according to actual stacking of plates of the coil.

In an embodiment, for example, five 3-dimensional Bitter disks with slits are assembled at a specific angle to form the coil model, which includes Bitter disks DISK1, DISK2, DISK3, DISK4, and DISK5 arranged in sequence from bottom to top, where angles of slits in DISK1 and DISK5 are both 180 degrees, and angles of slits in DISK2, DISK3 and DISK4 are 360-a degrees, 0 degrees, and a degrees respectively, where a is the sector angle of the insulating plate.

Specifically, between the Bitter disk DISK1 and the Bitter disk DISK2, a contact pair at a contact angle ranging from 360-2a to 360-a is a conductor-insulating plate contact pair, corresponding to a friction coefficient of fm-i, and a contact pair at a contact angle ranging from 0 to 360-2a or ranging from 360-a to 360 is a conductor-conductor contact pair, corresponding to a friction coefficient of fm-m.

Between the Bitter disk DISK2 and the Bitter disk DISK3, a contact pair at a contact angle ranging from 360-a to 360 is a conductor-insulating plate contact pair, corresponding to a friction coefficient of fm-i, and a contact pair at a contact angle ranging from 0 to 360-a is a conductor-conductor contact pair, corresponding to a friction coefficient of fm-m.

Between the Bitter disk DISK3 and the Bitter disk DISK4, a contact pair at a contact angle ranging from 0 to a is a conductor-insulating plate contact pair, corresponding to a friction coefficient of fm-i, and a contact pair at a contact angle ranging from a to 360 is a conductor-conductor contact pair, corresponding to a friction coefficient of fm-m.

Between the Bitter disk DISK4 and the Bitter disk DISK5, a contact pair at a contact angle ranging from a to 2a is a conductor-insulating plate contact pair, corresponding to a friction coefficient of fm-i, and a contact pair at a contact angle ranging from 0 to a or ranging from 2a to 360 is a conductor-conductor contact pair, corresponding to a friction coefficient of fm-m.

In an embodiment, the applying the corresponding node displacement coupling condition to the slit in each of the Bitter disks on the upper and lower end faces of the coil model includes: coupling displacements of corresponding nodes on the slit in each of the Bitter disks on the upper and lower end faces of the coil model respectively; and setting axial displacements of all nodes on the Bitter disk on the lower end face to 0, and setting all displacements of a node with a maximum node serial number on the Bitter disk on the lower end face to 0.

Specifically, in the embodiment, displacements of corresponding nodes on the slit in each of DISK1 and DISK5 are coupled respectively, that is, displacements of the corresponding nodes on each of DISK1 and DISK5 are equal. Moreover, axial displacements of all nodes on DISK1, i.e., the lower end face are set to 0; all displacements of the node with the maximum node serial number on DISK1 are set to 0, that is, displacements in the x-axis, y-axis, and z-axis directions are all 0.

Specifically, a 5-DISK model is assembled from 5 Bitter disks. Stacking of the 5 Bitter disks simulates the interaction scenario of the frictions between the Bitter disks. Functions of the five Bitter disks DISK1 to DISK5 are as follows. DISK1 and DISK5 are bottom and top Bitter disks, contact pairs are set on all contact surfaces located between DISK1 and DISK5 and a friction condition is introduced, and a corresponding node displacement coupling condition is applied to the slit in each of DISK1 and DISK5. The calculation is essentially to remove the slits, thereby achieving complete 360-degree continuity, and to simulate synchronous radial expansions of DISK1 and DISK5 under action of electromagnetic forces. One insulation angle is added between adjacent DISK2, DISK3 and DISK4 along a same direction to simulate actual arrangement in stacked plates of the coil, and there is no limitation on the slits in DISK2, DISK3 and DISK4. Therefore, each of DISK2, DISK3 and DISK4 is in a combined state of radial expansion and cantilever beam movement of the slit.

Only one side of DISK1 is in contact with DISK2, so DISK1 simulates a working condition of radial expansion and radial expansion plus slit cantilever beam movement under the action of friction. DISK2 is in contact with DISK1 and DISK3, DISK2 expands radially and the slit in DISK2 moves in a cantilever beam manner, DISK1 expands radially, DISK3 expands radially and the silt of DISK3 moves in a cantilever beam manner, so DISK2 simulates a working condition of radial expansion on one side and radial expansion plus cantilever beam movement of the slit on the other side under the action of frictions. DISK3 is in contact with DISK2 and DISK4, DISK3, DISK2 and DISK4 all expand radially and the slits in them all move in a cantilever beam manner, so DISK3 simulates a working condition of radial expansion plus cantilever beam movement of the slit on each of two sides under the action of frictions. The working condition of DISK3 is consistent with an actual working condition of the Bitter disk in the coil. Therefore, a stress state of DISK3 is an actual stress state we need to obtain.

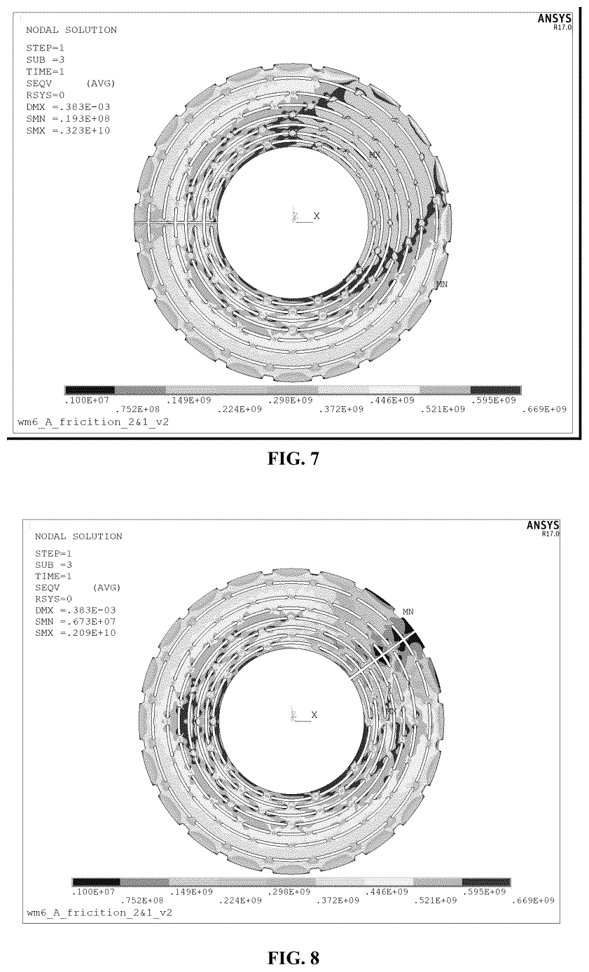

It is to be noted that in the embodiment, simulation of the radial electromagnetic forces and the axial electromagnetic forces of the Bitter disks, the frictions between the Bitter disks, and the slits in the Bitter disks is realized, the calculated stress distribution of the Bitter disks is more accurate and more consistent with the actual stress distribution. FIG. 7 illustrates that DISK1 forms a local stress concentration phenomenon under the action of friction (the gray part in the figure). FIG. 8 illustrates distribution of stress in a circumferential direction with the presence of the slit in DISK3.

In the embodiment, the interaction scenario of the frictions between the Bitter disks is simulated by stacking 5 Bitter disks, and the corresponding node displacement coupling condition is applied to the slit in each of the Bitter disks on the upper and lower end faces of the coil model. The calculation is essentially to remove the slits, thereby achieving complete 360-degree continuity, and to simulate synchronous radial expansions of the Bitter disks on the upper and lower end faces under the action of an electromagnetic force. For the Bitter disks between the upper and lower end faces, one insulation angle is added between adjacent disks along a same direction to simulate actual arrangement in stacked plates of the coil, and there is no limitation on the slits in the Bitter disks between the upper and lower end faces, so that the working condition of the Bitter disk in the coil model is consistent with an actual working condition of the Bitter disk in an actual water-cooled magnet coil.

Each step of the above method can be performed by any suitable apparatus that can perform a corresponding function. Such apparatus may include various hardware and/or software components and/or modules, including, but not limited to, circuits, application specific integrated circuits (ASICs), or processors. It should be understood that, although the steps in the flowcharts shown in the drawings are shown in sequence as indicated by the arrows, the steps are not necessarily performed in the order indicated by the arrows. Unless otherwise clearly specified herein, the steps are performed without any strict sequence limitation, and may be performed in other orders. In addition, at least some steps in the flowcharts shown in the drawings may include multiple sub-steps or multiple stages, and such sub-steps or stages are not necessarily performed at a same moment, and may be performed at different moments. The sub-steps or stages are not necessarily performed in sequence, and the sub-steps or stages and at least some of other steps or sub-steps or stages of other steps may be performed in turn or alternately.

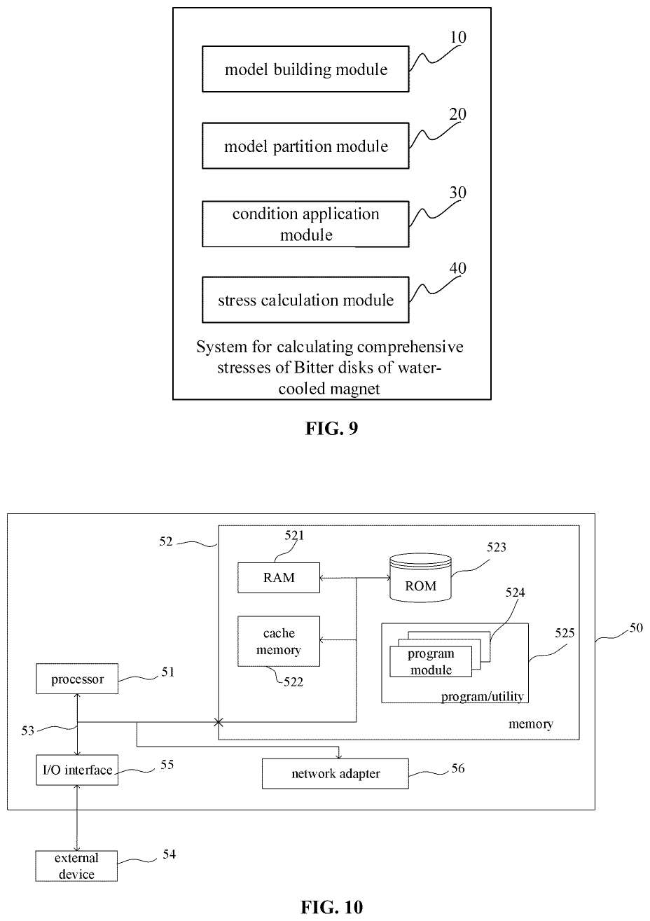

Referring to FIG. 9, a system for calculating comprehensive stresses of Bitter disks of a water-cooled magnet is further provided according to an embodiment the present disclosure. The system includes a model building module 10, a model partition module 20, a condition application module 30, and a stress calculation module 40.

The model building module 10 is configured to build, in a finite element analysis software, a simplified coil model by using multiple 3-dimensional Bitter disks each having a slit and having no helix angle. The model partition module 20 is configured to mesh the coil model to obtain meshed nodes. The condition application module 30 is configured to apply a boundary condition and a load condition to a meshed coil model and then perform simulation. The boundary condition includes: applying a corresponding node displacement coupling condition to the slit in each of the Bitter disks on upper and lower end faces of the coil model and setting contact pairs on all contact surfaces between the Bitter disks. The contact pairs include a conductor-insulating plate contact pair and a conductor-conductor contact pair. The load condition includes loading an electromagnetic force into all nodes of the coil model and applying an axial force to the upper end face of the coil model. The stress calculation module 40 is configured to calculate stress distribution of the Bitter disks based on a result of simulation.

In an embodiment, the condition application module 30 is further configured to set a friction coefficient between the conductor-insulating plate contact pair to an insulating contact surface friction coefficient, and set a friction coefficient between the conductor-conductor contact pair to a conductive contact surface friction coefficient.

In an embodiment, the coil model includes multiple Bitter disks arranged in sequence from bottom to top, and angles of slits in respective Bitter disks increase along a same direction.

In an embodiment, the applying the corresponding node displacement coupling condition to the slit in each of the Bitter disks on the upper and lower end faces of the coil model specifically includes: coupling displacements of corresponding nodes on the slit in each of the Bitter disks on the upper and lower end faces of the coil model respectively; and setting axial displacements of all nodes on the Bitter disk on the lower end face to 0, and setting all displacements of a node with a maximum node serial number on the Bitter disk on the lower end face to 0.

It is to be noted that, in the present disclosure, other embodiments or specific implementations of the system for calculating comprehensive stresses of the Bitter disks of the water-cooled magnet may be obtained with reference to the above embodiments directed to method, which are not repeated in detail herein.

The modules or units involved in the above system for calculating comprehensive stresses of Bitter disks of a water-cooled magnet may be implemented by hardware or software. In particular, each block in the block diagram illustrating the system for calculating comprehensive stresses of Bitter disks of the water-cooled magnet and combinations of blocks in the block diagram may be implemented with specialized hardware-based systems that perform specified functions or operations, or may be implemented using a combination of specialized hardware and computer instructions. It may be understood that the name of the module or unit does not constitute a limitation on the module or unit under certain circumstance. For example, the “model building module” may also be described as “module for building a model”.

FIG. 10 schematically illustrates a structure of an electronic device according to an embodiment of the present disclosure. The electronic device includes a memory, a processor, and a computer program stored in the memory and executable by the processor. When the processor executes the computer program, the method for calculating comprehensive stresses of Bitter disks of a water-cooled magnet described in the above embodiments is implemented. An electronic device 50 shown in FIG. 10 is merely an example, and should not bring any limitations to the functions and scope of use of the embodiments of the present disclosure.

As shown in FIG. 10, the electronic device 50 may be represented in the form of a computing device, such as a server device. Components of the electronic device 50 may include, but are not limited to: at least one processor 51, at least one memory 52, and a bus 53 connecting different system components (including the memory 52 and the processor 51).

The bus 53 includes a data bus, an address bus, and a control bus.

The memory 52 may include a volatile memory, such as a random access memory (RAM) 521 and/or a cache memory 522, and may further include a read-only memory (ROM) 523.

The memory 52 may further include a program/utility 525 having a set of program module(s) 524 (at least one program module 524). Such program module 524 includes, but is not limited to, an operating system, one or more application programs, other program modules, and program data. Each or a combination of these examples may include implementation of a network environment.

The processor 51 executes various functional applications and data processing by running computer programs stored in the memory 52, such as the medical image reconstruction method described in the first embodiment of the present disclosure.

The electronic device 50 may also communicate with one or more external devices 54 (such as a keyboard and a pointing device). Such communication may occur through an input/output (I/O) interface 55. Moreover, the model-generated device 50 may also communicate with one or more networks (e.g., a local area network (LAN), a wide area network (WAN), and/or a public network, such as the Internet) through a network adapter 56. As shown in FIG. 5, the network adapter 56 communicates with other modules of the model-generated device 50 via the bus 53. It should be understood that, although not shown, other hardware and/or software components may be used in conjunction with the model-generated device 50, including, but not limited to, microcode, device drivers, redundant processing units, external disk drive arrays, redundant arrays of independent disks (RAID) systems, tape drives, data archival storage systems, and the like.

It should be noted that, although several units/modules or sub-units/sub-modules of the electronic device are mentioned in the above detailed description, such division is merely exemplary and not mandatory. Actually, according to implementations of the present disclosure, the features and functions of two or more units/modules described above may be embodied in one unit/module. Conversely, the features and functions of one unit/module described above may be further divided into being embodied by multiple units/modules.

Embodiments of the present disclosure further provide a computer-readable storage medium. The computer-readable storage medium stores computer-executable instructions. When the computer-executable instructions are executed by the processor, the processor is caused to implement the method for calculating comprehensive stresses of Bitter disks of a water-cooled magnet described in the above embodiments.

The computer-readable storage medium may be a computer-readable signal medium or a computer-readable storage medium, or any combination thereof. For example, the computer-readable storage medium may be, but not limited to, an electronic, magnetic, optical, electromagnetic, infrared, or semiconductor system, apparatus, or device, or any combination thereof. More specific examples of the computer-readable storage medium may include, but not limited to, an electrical connection having one or more wires, a portable computer disk, a hard disk, a RAM, a ROM, an erasable programmable read-only memory (EPROM) or flash memory, an optical fiber, a portable compact disc read-only memory (CD-ROM), an optical storage device, a magnetic storage device, or any suitable combination thereof. In the present disclosure, the computer-readable storage medium may be any tangible medium that may include or store a program for use by or in connection with an instruction execution system, apparatus, or device. In the present disclosure, the computer-readable signal medium may include a data signal propagated in baseband or as part of a carrier wave, carrying computer-readable program code thereon. Such a propagated signal may take a variety of forms, including, but not limited to, electromagnetic signal, optical signal, or any suitable combination thereof. The computer-readable signal medium may alternatively be any computer-readable storage medium other than the computer-readable storage medium. The computer-readable signal medium may send, propagate, or transmit a program for use by or in connection with an instruction execution system, apparatus, or device. Computer codes included on the computer-readable storage medium may be transmitted through any appropriate medium, including, but not limited to, wires, optical cables, radio frequency (RF), and the like, or any suitable combination thereof.

Through the description of the above implementations, those skilled in the art can clearly understand that the methods in the above embodiments can be implemented by means of software plus a necessary general hardware platform; of course, they may alternatively be implemented by hardware. In many cases, the former is preferred. Based on such understanding, the technical solutions in the present disclosure essentially or the part contributing to the prior art may be implemented in the form of a software product. The computer software product is stored in a storage medium (such as a ROM/RAM, a magnetic disc, or an optical disc) as described above, and includes several instructions for instructing a terminal device (which may be a mobile phone, a computer, a server, a network device, or the like) to perform the methods described in the embodiments of the present disclosure.

Although the embodiments of the present disclosure have been shown and described above, it may be understood that the above embodiments are illustrative and cannot be construed as limiting the present disclosure. Those of ordinary skill in the art may make changes, modifications, substitutions, and variations to the above embodiments within the scope of the present disclosure.

1. A method for calculating comprehensive stresses of Bitter disks of a water-cooled magnet, comprising:
building, in a finite element analysis software, a simplified coil model by using a plurality of 3-dimensional Bitter disks each having a slit and have no helix angle;
meshing the coil model to obtain meshed nodes;
applying a boundary condition and a load condition to a meshed coil model and then performing simulation, wherein the boundary condition comprises: applying a corresponding node displacement coupling condition to the slit in each of the Bitter disks on upper and lower end faces of the coil model and setting contact pairs on all contact surfaces between the Bitter disks, wherein the contact pairs comprise a conductor-insulating plate contact pair and a conductor-conductor contact pair, and wherein the load condition comprises loading an electromagnetic force into all nodes of the coil model and applying an axial force to the upper end face of the coil model; and
calculating stress distribution of the Bitter disks based on a result of simulation.

2. The method according to claim 1, further comprising: setting a friction coefficient between the conductor-insulating plate contact pair to an insulating contact surface friction coefficient, and setting a friction coefficient between the conductor-conductor contact pair to a conductive contact surface friction coefficient.

3. The method according to claim 1, wherein the coil model comprises a plurality of Bitter disks arranged in sequence from bottom to top, and angles of the slits in respective Bitter disks increase along a same direction.

4. The method according to claim 3, wherein the coil model comprises Bitter disks DISK1, DISK2, DISK3, DISK4 and DISK5 arranged in sequence from bottom to top, the angles of the slits in DISK1 and DISK5 are both 180 degrees, and the angles of the slits in DISK2, DISK3 and DISK4 are 360-a degrees, 0 degrees, and a degrees respectively, where a is a sector angle of an insulating plate.

5. The method according to claim 4, wherein between the Bitter disk DISK1 and the Bitter disk DISK2, a contact pair at a contact angle ranging from 360-2a to 360-a is a conductor-insulating plate contact pair, and a contact pair at a contact angle ranging from 0 to 360-2a or ranging from 360-a to 360 is a conductor-conductor contact pair;
between the Bitter disk DISK2 and the Bitter disk DISK3, a contact pair at a contact angle ranging from 360-a to 360 is a conductor-insulating plate contact pair, and a contact pair at a contact angle ranging from 0 to 360-a is a conductor-conductor contact pair;
between the Bitter disk DISK3 and the Bitter disk DISK4, a contact pair at a contact angle ranging from 0 to a is a conductor-insulating plate contact pair, and a contact pair at a contact angle ranging from a to 360 is a conductor-conductor contact pair; and
between the Bitter disk DISK4 and the Bitter disk DISK5, a contact pair at a contact angle ranging from a to 2a is a conductor-insulating plate contact pair, and a contact pair at a contact angle ranging from 0 to a or ranging from 2a to 360 is a conductor-conductor contact pair.

6. The method according to claim 4, wherein each of the Bitter disk DISK2, DISK3 and DISK4 is in a combined state of radial expansion and cantilever beam movement of the slit.

7. The method according to claim 1, wherein the applying the corresponding node displacement coupling condition to the slit in each of the Bitter disks on the upper and lower end faces of the coil model comprises:
coupling displacements of corresponding nodes on the slit in each of the Bitter disks on the upper and lower end faces of the coil model respectively; and
setting axial displacements of all nodes on the Bitter disk on the lower end face to 0, and setting all displacements of a node with a maximum node serial number on the Bitter disk on the lower end face to 0.

8. A system for calculating comprehensive stresses of Bitter disks of a water-cooled magnet, comprising a memory, a processor, and a computer program stored in the memory and executable by the processor, wherein the processor, when executing the computer program, implements:
building, in a finite element analysis software, a simplified coil model by using a plurality of 3-dimensional Bitter disks each having a slit and have no helix angle;
meshing the coil model to obtain meshed nodes;
applying a boundary condition and a load condition to a meshed coil model and then performing simulation, wherein the boundary condition comprises: applying a corresponding node displacement coupling condition to the slit in each of the Bitter disks on upper and lower end faces of the coil model and setting contact pairs on all contact surfaces between the Bitter disks, wherein the contact pairs comprise a conductor-insulating plate contact pair and a conductor-conductor contact pair, and wherein the load condition comprises loading an electromagnetic force into all nodes of the coil model and applying an axial force to the upper end face of the coil model; and
calculating stress distribution of the Bitter disks based on a result of simulation.

9. The system according to claim 8, wherein the processor, when executing the computer program, further implements: setting a friction coefficient between the conductor-insulating plate contact pair to an insulating contact surface friction coefficient, and setting a friction coefficient between the conductor-conductor contact pair to a conductive contact surface friction coefficient.

10. The system according to claim 8, wherein the coil model comprises a plurality of Bitter disks arranged in sequence from bottom to top, and angles of the slits in respective Bitter disks increase along a same direction.

11. The system according to claim 10, wherein the coil model comprises Bitter disks DISK1, DISK2, DISK3, DISK4 and DISK5 arranged in sequence from bottom to top, the angles of the slits in DISK1 and DISK5 are both 180 degrees, and the angles of the slits in DISK2, DISK3 and DISK4 are 360-a degrees, 0 degrees, and a degrees respectively, where a is a sector angle of an insulating plate.

12. The system according to claim 11, wherein between the Bitter disk DISK1 and the Bitter disk DISK2, a contact pair at a contact angle ranging from 360-2a to 360-a is a conductor-insulating plate contact pair, and a contact pair at a contact angle ranging from 0 to 360-2a or ranging from 360-a to 360 is a conductor-conductor contact pair;
between the Bitter disk DISK2 and the Bitter disk DISK3, a contact pair at a contact angle ranging from 360-a to 360 is a conductor-insulating plate contact pair, and a contact pair at a contact angle ranging from 0 to 360-a is a conductor-conductor contact pair;
between the Bitter disk DISK3 and the Bitter disk DISK4, a contact pair at a contact angle ranging from 0 to a is a conductor-insulating plate contact pair, and a contact pair at a contact angle ranging from a to 360 is a conductor-conductor contact pair; and
between the Bitter disk DISK4 and the Bitter disk DISK5, a contact pair at a contact angle ranging from a to 2a is a conductor-insulating plate contact pair, and a contact pair at a contact angle ranging from 0 to a or ranging from 2a to 360 is a conductor-conductor contact pair.

13. The system according to claim 11, wherein each of the Bitter disks DISK2, DISK3 and DISK4 is in a combined state of radial expansion and cantilever beam movement of the slit.

14. The system according to claim 11, wherein applying the corresponding node displacement coupling condition to the slit in each of the Bitter disks on the upper and lower end faces of the coil model comprises:
coupling displacements of corresponding nodes on the slit in each of the Bitter disks on the upper and lower end faces of the coil model respectively; and
setting axial displacements of all nodes on the Bitter disk on the lower end face to 0, and setting all displacements of a node with a maximum node serial number on the Bitter disk on the lower end face to 0.

15. (canceled)

16. A computer-readable storage medium, having computer-executable instructions stored thereon, wherein the computer-executable instructions, when executed by a processor, cause the processor to implement the method according to claim 1.
